(19) United States
(12) Patent Application Publication
(10) Pub. No.: US 2016/0042858 A1
(43) Pub. Date: Feb. 11, 2016

(54) CHIP-TYPE COIL COMPONENT AND MANUFACTURING METHOD THEREOF

(71) Applicant: SAMSUNG ELECTRO-MECHANICS CO., LTD., Suwon-Si (KR)

(72) Inventors: Yong Sun PARK, Suwon-Si (KR); Jae Yeol CHOI, Suwon-Si (KR); Sung Jin PARK, Suwon-Si (KR)

(21) Appl. No.: 14/677,803

(22) Filed: Apr. 2, 2015

(30) Foreign Application Priority Data
Aug. 11, 2014 (KR) 10-2014-0103788

(51) Int. Cl. H01F 27/28; H01F 41/00; H01F 27/29

(52) U.S. Cl. CPC H01F 27/2804; H01F 27/29; H01F 41/00; H01F 2027/2809

(57) ABSTRACT

A chip-type coil component may include: a ceramic body of which a lower surface is provided as a mounting surface and in which a plurality of ceramic layers with a plurality of recesses provided therein are stacked; and an internal coil structure disposed within the ceramic body and including internal coil patterns disposed on the plurality of ceramic layers, wherein the plurality of recesses are exposed to the lower surface of the ceramic body, and the plurality of recesses are filled with a plurality of conductive materials.

### CROSS-REFERENCE TO RELATED APPLICATION

This application claims priority to, and the benefit of, Korean Patent Application No. 10-2014-0103788 filed on Aug. 11, 2014, with the Korean Intellectual Property Office, the disclosure of which is incorporated herein by reference.

### BACKGROUND

The present disclosure relates to a chip-type coil component and a manufacturing method thereof.

An inductor, a multilayer chip component, is a typical passive element forming an electronic circuit, together with a resistor and a capacitor, to cancel noise, or is used as a component to form an LC resonance circuit.

Multilayer inductors, recently prevalent in a wide variety of devices, have a structure in which a plurality of ceramic layers, each having an internal coil pattern formed thereon, are laminated such that the internal coil patterns are connected to forma coil structure with desired characteristics, such as intended degrees of inductance and impedance.

However, a related art inductor having electrodes on a bottom surface thereof requires an additional process of connecting internal electrodes exposed after being printed through vias or forming an extra external electrode.

### RELATED ART DOCUMENT

(Patent Document 1) Japanese Patent Laid-Open Publication No. 2010-165973

### SUMMARY

An exemplary embodiment in the present disclosure may provide a chip-type coil component in which external electrodes are formed simultaneously while ceramic layers are stacked by filling a plurality of recesses formed in the ceramic layers with a plurality of conductive materials, and a manufacturing method thereof.

According to an exemplary embodiment in the present disclosure, a chip-type coil component may include a ceramic body of which a lower surface is provided as amounting surface and in which a plurality of ceramic layers with a plurality of recesses provided therein are stacked; and an internal coil structure disposed within the ceramic body and including internal coil patterns disposed on the plurality of ceramic layers, wherein the plurality of recesses may be exposed to the lower surface of the ceramic body and the plurality of recesses are filled with a plurality of conductive materials.

According to another exemplary embodiment in the present disclosure, a chip-type coil component may include: a ceramic body in which a plurality of ceramic layers are stacked and of which a lower surface is provided as amounting surface; an internal coil structure including internal coil patterns which are disposed on the plurality of ceramic layers and electrically connected to each other within the ceramic body, and having a first lead-out portion and a second lead-out portion which are exposed to the lower surface of the ceramic body which is perpendicular to a stacked direction of the ceramic layers; first and second external electrodes disposed on the lower surface of the ceramic body which is perpendicular to the stacked direction of the ceramic layers and connected to the first and second lead-out portions, respectively, wherein the plurality of ceramic layers may include first and second recesses exposed to the lower surface of the ceramic body, and the first and second external electrodes may include conductive materials filling the first and second recesses.

According to another exemplary embodiment in the present disclosure, a method for manufacturing a chip-type coil component may include: preparing a plurality of ceramic layers, each of which having first and second recesses; filling the first and second recesses with a plurality of conductive materials; forming internal coil patterns on the plurality of ceramic layers; connecting via holes to the internal coil patterns and stacking the plurality of ceramic layers having the internal coil patterns formed thereon to form a ceramic body, wherein the ceramic body may have a lower surface provided as a mounting surface and an upper surface opposing the lower surface, and the first and second recesses may be exposed to the lower surface of the ceramic body.

### BRIEF DESCRIPTION OF DRAWINGS

The above and other aspects, features and advantages in the present disclosure will be more clearly understood from the following detailed description taken in conjunction with the accompanying drawings, in which:

FIG. 1 is a perspective view illustrating a chip-type coil component with an internal coil structure according to an exemplary embodiment in the present disclosure;

FIG. 2 is a perspective view illustrating a ceramic layer having a plurality of recesses in the chip-type coil component according to an exemplary embodiment in the present disclosure;

FIG. 3 is an exploded perspective view of the chip-type coil component illustrated in FIG. 1;

FIG. 4 is a cross-sectional view of the chip-type coil component illustrated in FIG. 1 taken in a length direction;

FIG. 5 is a bottom view of the chip-type coil component illustrated in FIG. 1;

FIG. 6 is a flowchart illustrating a method for manufacturing a chip-type coil component according to an exemplary embodiment in the present disclosure; and

FIG. 7 is a perspective view illustrating preparation of a plurality of ceramic layers according to the method for manufacturing a chip-type coil component illustrated in FIG. 6.

### DETAILED DESCRIPTION

Exemplary embodiments in the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Chip-Type Coil Component

Hereinafter, a multilayer electronic component according to an exemplary embodiment in the present disclosure, in particular, a multilayer inductor, will be described, but types of multilayer electronic components are not limited thereto.

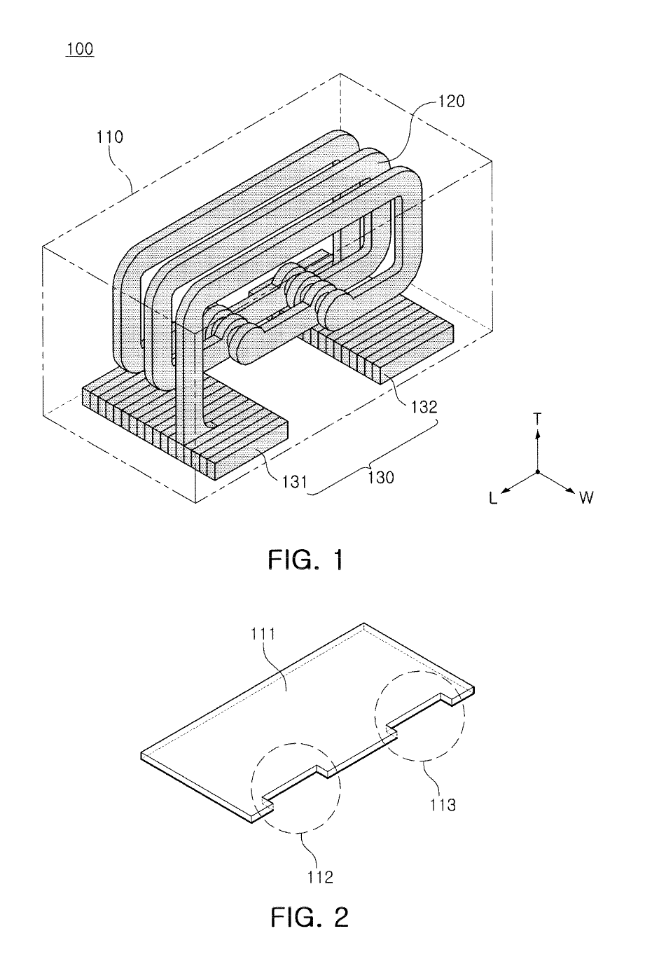

FIG. 1 is a perspective view illustrating a chip-type coil component 100 with an internal coil structure according to an exemplary embodiment in the present disclosure.

Referring to FIG. 1, the chip-type coil component 100 according to an exemplary embodiment in the present disclosure may include a ceramic body 110 and an internal coil structure.

The ceramic body 110 may be formed by stacking a plurality of ceramic layers having a plurality of recesses. Also, the plurality of ceramic layers forming the ceramic body 110 may be in a sintered state and may each be integrated such that boundaries therebetween may not be readily apparent without using a scanning electron microscope (SEM).

The ceramic body 110 may have a hexahedral shape, for example. In order to clarify the present exemplary embodiment, L, W, and T, defining directions of a hexahedron (six-sided object) shown in FIG. 1, indicate a length direction, a width direction, and a thickness direction, respectively.

Also, the ceramic body 110 may have a lower surface provided as a mounting surface, an upper surface opposing the lower surface, both lateral surfaces in the length direction, and both lateral surfaces in the width direction.

The plurality of ceramic layers may include known dielectric material and ferrite such as an Al₂O₃-based dielectric material, Mn—Zn-based ferrite, Ni—Zn-based ferrite, Ni—Zn—Cu-based ferrite, Mn—Mg-based ferrite, Ba-based ferrite, and Li-based ferrite.

The internal coil structure may be disposed within the ceramic body 110. Also, the internal coil structure may include an internal coil pattern 120 disposed on the plurality of ceramic layers. Here, the plurality of stacked ceramic layers with the internal coil pattern 120 formed thereon may form the ceramic body 110, and the internal coil pattern 120 may form the internal coil structure within the ceramic body 110.

The internal coil structure may be disposed to be perpendicular with respect to the lower surface of the ceramic body 110 within the ceramic body 110.

Namely, the internal coil structure disposed within the ceramic body 110 may be disposed such that a virtual central axis penetrating through the center of the internal coil structure is parallel to an upper surface or the lower surface of the ceramic body 110 in the thickness direction.

Namely, the internal coil pattern 120 formed on the plurality of ceramic layers may be electrically connected by via holes to form a single internal coil structure, thus realizing intended inductance.

The internal coil structure may be formed by printing conductive paste including a conductive metal. The conductive metal is not particularly limited as long as a metal has excellent electrical conductivity, and for example, the conductive metal may be formed of silver (Ag), palladium (Pd), aluminum (Al), nickel (Ni), titanium (Ti), gold (Au), copper (Cu), or platinum (Pt) alone or any mixture thereof.

FIG. 2 is a perspective view illustrating a ceramic layer 111 having a plurality of recesses 112 and 113 in the chip-type coil component 100 according to an exemplary embodiment in the present disclosure.

Here, the internal coil pattern 120 formed on the plurality of ceramic layers will be described by using the same reference numeral.

Referring to FIG. 2, among the components of the chip-type coil component 100 according to an exemplary embodiment in the present disclosure, the ceramic body 110 may include a ceramic layer 111 having a plurality of recesses 112 and 113.

In FIG. 2, two recesses 112 and 113 are illustrated, but the number of recesses is not limited to two and may vary depending on a shape of an external electrode. Also, the recesses 112 and 113 are illustrated as having a rectangular shape in FIG. 2, but the shape of the recesses is not limited thereto and may vary depending on a shape of an electrode.

Hereinafter, it is assumed that the recesses 112 and 113 have a rectangular shape and two recesses 112 and 113 are provided.

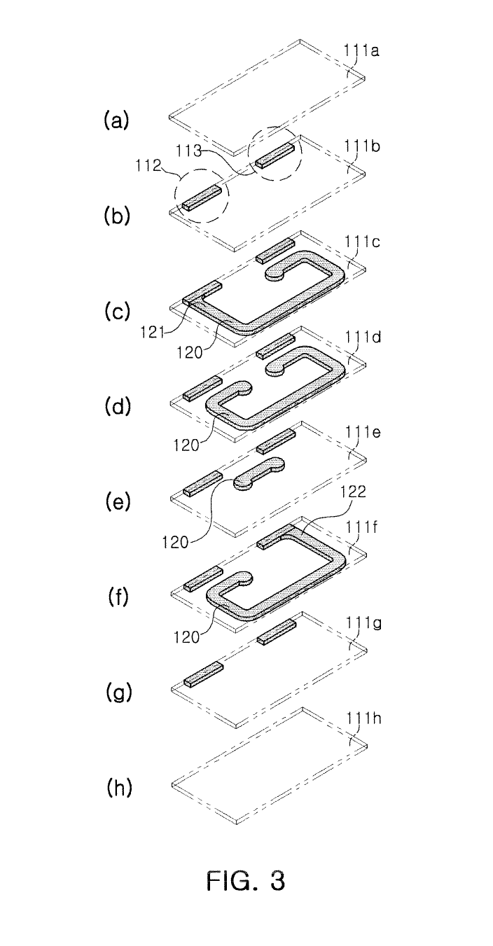

The recesses 112 and 113 may be filled with a plurality of conductive materials. This will be described in detail with reference to FIG. 3.

FIG. 3 is an exploded perspective view of the chip-type coil component 100 illustrated in FIG. 1.

Referring to FIG. 3, the chip-type coil component 100 according to an exemplary embodiment in the present disclosure may include a plurality of ceramic layers 111a to 111h forming the ceramic body 110.

Here, the plurality of ceramic layers 111a to 111h forming the ceramic body 110 may include ceramic layers 111a, 111b, 111g, and 111h without the internal coil pattern 120.

The plurality of ceramic layers 111c to 111f each with the internal coil pattern 120 formed thereon may be variously modified depending on intended inductance, rather than being uniformly determined.

The ceramic body 110 may include the ceramic layers 111a and 111h without both the recesses 112 and 113 and the internal coil pattern 120. Here, the plurality of ceramic layers 111b to 111g may be positioned between the ceramic layer 111a and the ceramic layer 111h.

Namely, the ceramic layers 111a and 111h may serve as protective layers protecting the interior of the ceramic body 110.

The internal coil patterns 120 may be formed on the plurality of ceramic layers 111c to 111f and may be connected by a plurality of via holes (not shown) in a stacked direction of the ceramic layers to forma single internal coil structure.

The plurality of ceramic layers 111b to 111g may include a plurality of recesses 112 and 113.

The plurality of recesses 112 and 113 formed on the plurality of ceramic layers 111b to 111g may be filled with a plurality of conductive materials. Namely, conductive materials filling the recesses 112 and 113 of the plurality of ceramic layers 111b to 111g may form first and second external electrodes 131 and 132 (please refer to FIG. 1).

Here, the plurality of recesses 112 and 113 may be formed on the same position of the plurality of ceramic layers 111b to 111g, and accordingly, when the plurality of ceramic layers 111b to 111g are stacked, the recesses 112 and 113 may be connected according to the stacked direction.

The plurality of conductive materials may include silver (Ag), silver-palladium (Ag—Pd), nickel (Ni), copper (Cu), and the like.

The recesses 112 and 113 may be formed to be exposed to a lower surface of the ceramic body 110. Namely, the first and second external electrodes 131 and 132 generated by filling the recesses 112 and 113 with conductive materials may be formed on the lower surface of the ceramic body 110 so as to be exposed outwardly.

The first and second external electrodes 131 and 132 may be formed to be spaced apart from one another on the lower surface of the ceramic body 110.

Referring to FIG. 3(c), the internal coil pattern 120 formed on the ceramic layer 111c may include a first lead-out portion 121 connected to the first recess 112.

Referring to FIG. 3(f), the internal coil pattern 120 formed on the ceramic layer 111f may include a second lead-out portion 122 connected to the second recess 113.

Namely, the first and second external electrodes 131 and 132 formed by filling the plurality of recesses 112 and 113 with conductive materials may be electrically connected to the first lead-out portion 121 and the second lead-out portion 122.

Thus, in the chip-type coil component 100 according to an exemplary embodiment, the plurality of recesses 112 and 113 are formed in the ceramic layers 111b to 111g such that the plurality of recesses 112 and 113 are exposed to the lower surface of the ceramic body 110 and filled with conductive materials, and the plurality of ceramic layers 111a to 111h are subsequently stacked in the stacked direction, thus forming the ceramic body 110.

Thus, in the chip-type coil component 100 according to an exemplary embodiment in the present disclosure, the external electrodes 131 and 132 may be formed simultaneously when the ceramic layers are stacked without any extra process to form the external electrodes.

Also, since a dielectric layer is not present in the interface between the external electrode 130 and the internal coil pattern 120, there is no need to form an extra recess in a portion in which the external electrode 130 is formed, and connect the same.

Also, in the chip-type coil component 100 according to an exemplary embodiment in the present disclosure, since the external electrodes are formed simultaneously when the ceramic layers are stacked without any extra process to form the external electrodes, a marking pattern indicating a direction of the internal coil patterns may be omitted.

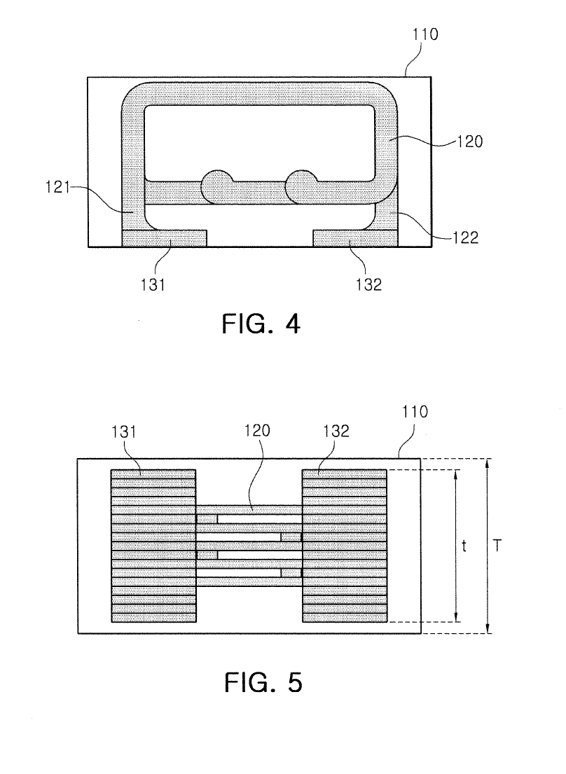

FIG. 4 is a cross-sectional view of the chip-type coil component 100 illustrated in FIG. 1 taken in the length direction.

Referring to FIG. 4, the ceramic body 110 may include the internal coil pattern 120 and the first and second lead-out portions 121 and 122 formed therein. Also, the first and second external electrodes 131 and 132 formed by filling the plurality of recesses 112 and 113 formed in the plurality of ceramic layers 111 with the conductive materials may be coplanar with the surface of the ceramic body 110 which is perpendicular to the stacked direction of the ceramic layers.

FIG. 5 is a bottom view of the chip-type coil component 100 illustrated in FIG. 1.

Referring to FIG. 5, the chip-type coil component 100 according to an exemplary embodiment in the present disclosure, when a width of the ceramic body 110 is T and a length of the first or second external electrode 131 or 132 is t, 2/T<t<T may be satisfied. Here, when the first and second external electrodes 131 and 132 have a rectangular shape, the length t of the first or second external electrode 131 or 132 may be obtained by measuring the longest side thereof.

Namely, referring to FIGS. 2 and 5, in the chip-type coil component 100 according to an exemplary embodiment, when the plurality of ceramic layers 111b to 111g with the recesses 112 and 113 formed thereon may be continuously stacked as illustrated in FIG. 2, and here, the laminating number may be adjusted to satisfy 2/T<t<T.

Method for Manufacturing Chip-Type Coil Component

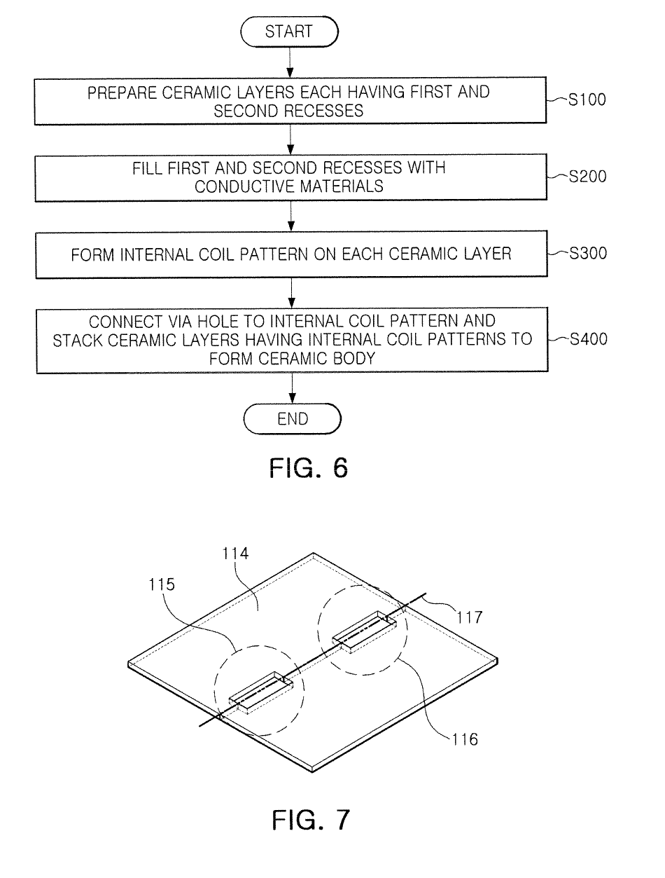

FIG. 6 is a flowchart illustrating a method for manufacturing a chip-type coil component according to an exemplary embodiment in the present disclosure.

Referring to FIGS. 6 and 3, a method for manufacturing a chip-type coil component according to an exemplary embodiment in the present disclosure may include an operation (S100) of preparing a plurality of ceramic layers 111a to 111h each having first and second recesses 112 and 113, an operation (S200) of filling the first and second recesses 112 and 113 with a plurality of conductive materials, an operation (S300) of forming internal coil patterns 120 on some (ceramic layers 111c to 111f) of the plurality of ceramic layers, and an operation (S400) of connecting via holes to the internal coil patterns 120 and stacking the plurality of ceramic layers 111a to 111h to form the ceramic body 110.

Here, in FIG. 6, it is described that operation (S300) of forming the internal coil patterns 120 and the via holes is performed after operation (S200) of filling the first and second recesses 112 and 113 with the plurality of conductive materials, but the operations S200 and S300 may be interchanged in order.

The plurality of ceramic layers 111a to 111h may be stacked such that the first and second recesses 112 and 113 are exposed to the lower surface of the ceramic body 110, and thus, the chip-type coil component in which the internal coil structure is vertical may be formed.

FIG. 7 is a perspective view illustrating preparation of a plurality of ceramic layers according to the method for manufacturing a chip-type coil component according to an exemplary embodiment in the present disclosure.

Referring to FIGS. 6 and 7, as for formation of the plurality of ceramic layers 111a to 111h, a ceramic sheet 114 may be prepared and two recesses 115 and 116 having a predetermined area may be formed on the ceramic sheet 114. Here, the two recesses 115 and 116 may be positioned in a central portion of the ceramic sheet 114.

Namely, a virtual line 117 connecting the two recesses 115 and 116 of the ceramic sheet 114 may be drawn and the ceramic sheet 114 may be cut along the virtual line 117, in order to form the plurality of ceramic layers 111a to 111h having the first and second recesses 112 and 113.

The number of the plurality of ceramic layers may not be limited to the number illustrated in FIG. 3. Namely, when the width of the ceramic body 110 is T and the length of the first or second external electrode 131 or 132 formed by filling the first or second recess 112 or 113 with a plurality of conductive materials is t, the number of the plurality of stacked ceramic layers may be adjusted to satisfy 2/T<t<T.

Thus, in the method for manufacturing a chip-type coil component according to an exemplary embodiment in the present disclosure, the external electrodes may be formed simultaneously when the ceramic layers are stacked without any extra process to form the external electrodes, thus simplifying the manufacturing process.

Also, in the method for manufacturing a chip-type coil component according to an exemplary embodiment in the present disclosure, since the external electrodes are formed simultaneously when the ceramic layers are stacked without any extra process to form the external electrodes, a marking pattern indicating a direction of the internal coil patterns may be omitted.

As set forth above, in the chip-type coil component and the manufacturing method thereof according to exemplary embodiments in the present disclosure, the external electrodes may be formed simultaneously when the ceramic layers are stacked without any extra process to form the external electrodes, thus simplifying the manufacturing process.

While exemplary embodiments have been shown and described above, it will be apparent to those skilled in the art that modifications and variations could be made without departing from the scope of the present invention as defined by the appended claims.

What is claimed is:

1. A chip-type coil component comprising:
a ceramic body including a lower surface provided as a mounting surface, a plurality of ceramic layers with a plurality of recesses being stacked in the ceramic body; and
an internal coil structure disposed within the ceramic body and including internal coil patterns disposed on the plurality of ceramic layers,
wherein the plurality of recesses are exposed to the lower surface of the ceramic body, and
the plurality of recesses are filled with a plurality of conductive materials.

2. The chip-type coil component of claim 1, wherein the internal coil patterns are connected to each other by a plurality of via holes in a stacked direction of the ceramic layers.

3. The chip-type coil component of claim 1, wherein portions of the plurality of conductive materials filling the plurality of recesses are coplanar with the lower surface of the ceramic body which is perpendicular to a stacked direction of the ceramic layers.

4. The chip-type coil component of claim 1, wherein the plurality of ceramic layers are stacked in a direction perpendicular to the lower surface of the ceramic body to be mounted on a board.

5. A chip-type coil component comprising:
a ceramic body including a plurality of ceramic layers stacked, and a lower surface provided as a mounting surface;
an internal coil structure including internal coil patterns which are disposed on the plurality of ceramic layers and electrically connected to each other within the ceramic body, and having a first lead-out portion and a second lead-out portion which are exposed to the lower surface of the ceramic body which is perpendicular to a stacked direction of the ceramic layers;
first and second external electrodes disposed on the lower surface of the ceramic body which is perpendicular to the stacked direction of the ceramic layers and connected to the first and second lead-out portions, respectively,
wherein the plurality of ceramic layers include first and second recesses exposed to the lower surface of the ceramic body, and
the first and second external electrodes include conductive materials filling the first and second recesses.

6. The chip-type coil component of claim 5, wherein when a width of the ceramic body is T and a length of the first or second external electrode is t, 2/T<t<T is satisfied.

7. The chip-type coil component of claim 5, wherein the internal coil patterns are connected to each other by a plurality of via holes in the stacked direction of the ceramic layers.

8. The chip-type coil component of claim 5, wherein the plurality of ceramic layers are stacked in a direction perpendicular to the lower surface of the ceramic body to be mounted on a board.

9. The chip-type coil component of claim 5, wherein the first and second external electrodes are coplanar with the lower surface of the ceramic body which is perpendicular to the stacked direction of the ceramic layers.

10. A method for manufacturing a chip-type coil component, the method comprising:
preparing a plurality of ceramic layers, each of which having first and second recesses;
filling the first and second recesses with a plurality of conductive materials and forming internal coil patterns on and via holes in the plurality of ceramic layers; and
stacking the plurality of ceramic layers having the internal coil patterns formed thereon to form a ceramic body,
wherein the ceramic body has a lower surface provided as a mounting surface and an upper surface opposing the lower surface, and
the first and second recesses are exposed to the lower surface of the ceramic body.

11. The method of claim 10, wherein the preparing of the plurality of ceramic layers includes:
preparing a ceramic sheet; and
forming two recesses having a predetermined area in the ceramic sheet,
wherein the two recesses are positioned in a central portion of the ceramic sheet.

12. The method of claim 11, further comprising cutting the ceramic sheet along a virtual line connecting the two recesses of the ceramic sheet to prepare a plurality of ceramic layers having the first and second recesses.

13. The method of claim 10, wherein the forming of the ceramic body includes stacking the plurality of ceramic layers in a direction perpendicular to the lower surface of the ceramic body to be mounted on a board.

14. The method of claim 10, wherein when a width of the ceramic body is T and a length of first or second external electrode formed by filling the first and second recesses with the plurality of conductive materials is t, 2/T<t<T is satisfied.
